(19) United States
(12) Patent Application Publication
(10) Pub. No.: US 2021/0408607 A1
(43) Pub. Date: Dec. 30, 2021

(54) METHOD FOR MANUFACTURING LITHIUM-ION RECHARGEABLE BATTERY, LITHIUM-ION RECHARGEABLE BATTERY, AND ASSEMBLED BATTERY OF LITHIUM-ION RECHARGEABLE BATTERIES

(71) Applicant: PRIMEARTH EV ENERGY CO., LTD., Kosai-shi (JP)

(72) Inventor: Shigeki SAITO, Hamamatsu-shi (JP)

(73) Assignee: PRIMEARTH EV ENERGY CO., LTD., Kosai-shi (JP)

(21) Appl. No.: 17/354,230

(22) Filed: Jun. 22, 2021

(30) Foreign Application Priority Data
Jun. 26, 2020 (JP) 2020-110291

(51) Int. Cl. H01M 10/0585; H01M 50/566; H01M 50/562; H01M 10/0525; H01M 50/505

(52) U.S. Cl. CPC H01M 10/0585; H01M 50/566; H01M 50/505; H01M 10/0525; H01M 50/562

(57) ABSTRACT

A lithium-ion rechargeable battery includes a current collector terminal and a negative terminal unit connected to the current collector terminal. The negative terminal unit is configured to conduct electricity from an inside to an outside of a battery case. The negative terminal unit is formed of copper (Cu) or its alloy and includes a fixing member fixing the battery case to the current collector terminal. The battery is manufactured by ultrasonically bonding an external terminal formed of aluminum (Al) or its alloy to the top of a negative fixing member, fitting a busbar to a negative external terminal, and laser-welding the busbar to the negative external terminal and using the welding heat to heat the external terminal that has undergone the ultrasonic bonding to form a diffusion-bonded portion and an intermolecular-bonded portion in a bonded surface of the external terminal and the negative fixing member. Thus, conductivity is increased.

### BACKGROUND

### 1. Field

The following description relates to a lithium-ion rechargeable battery, a method for manufacturing a lithium-ion rechargeable battery, and an assembled battery of lithium-ion rechargeable batteries. More specifically, the following description relates to a lithium-ion rechargeable battery including a current collector terminal that is electrically connected to a power generating element and an external terminal that is connected to the current collector terminal, a method for manufacturing the lithium-ion rechargeable battery, and an assembled battery of the lithium-ion rechargeable batteries.

### 2. Description of Related Art

An electrically driven vehicle, for example, an electric car or a hybrid vehicle, which includes a motor and an engine as drive sources of the vehicle, uses a rechargeable battery as a power supply. An example of the rechargeable battery is a lithium-ion rechargeable battery.

In the lithium-ion rechargeable battery, aluminum (Al) or an Al-base metal material of an Al alloy is used as the base material of a positive electrode plate or a positive current collector to inhibit chemical reactions with a positive active material. Copper (Cu) or a Cu-base metal material of a Cu alloy has a low electric resistance and is used as the base material of a negative electrode plate or a negative current collector. A material that is readily welded to a current collector is selected for a terminal unit exposed to the exterior of the battery. An Al-base material is used for the positive electrode portion. A Cu-base material is used for the negative electrode portion. The material of each component in the lithium-ion battery is mainly selected as described above.

To achieve further reduction in weight and size (reduction in volume) of the lithium-ion battery and improve the productivity of the lithium-ion battery, a busbar is connected to a battery terminal by welding instead of mechanical swaging. In addition, a conventional busbar formed of a Cu-base material is replaced with a busbar formed of an Al-base material. The Al-base material has a lower density (specific weight) than the Cu-base material and allows for weight reduction. For example, a busbar formed of an Al-base material is readily welded to the positive electrode portion formed of Al.

However, when the busbar formed of an Al-base material is welded to the negative electrode portion formed of Cu, the heat of welding causes a reaction that produces an intermetallic compound having a low mechanical strength due to an inclination of compositions of Al and Cu in the bonded interface. This lowers bonding strength.

FIG. 22 is a cross-sectional view of a terminal unit 40 of a lithium-ion rechargeable battery disclosed in Japanese Laid-Open Patent Publication No. 2017-228418. In Japanese Laid-Open Patent Publication No. 2017-228418, to prevent production of an intermetallic compound when bonding terminals formed of different metal materials, an ultrasonic horn solid-phase-bonds an Al external terminal 45 to an end 50 of a Cu current corrector terminal 42 to establish electrical connection toward the current collector terminal 42. The head of a connection terminal 47 is received in an opening 43B of an insulator 43. The connection terminal 47 includes a leg extending from the head and inserted through a hole 49 in the external terminal 45. The connection terminal 47 is electrically connected to the external terminal 45.

This configuration allows for the use of Al or an Al alloy as the material of the external terminal 45 even when the current collector terminal 42 is formed of a material other than Al or an Al alloy and achieves the weight reduction of the battery.

When the external terminal 45 is solid-phase-bonded to the current collector terminal 42 by the ultrasonic horn, mechanical strength and certain conductivity are obtained. However, there is a demand for a higher conductivity in a recent lithium-ion rechargeable battery.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present disclosure is a method for manufacturing a lithium-ion rechargeable battery. The lithium-ion rechargeable battery includes a power generating element, a battery case accommodating the power generating element, a current collector terminal electrically connected to a negative electrode body of the power generating element, and a negative terminal unit connected to the current collector terminal and configured to conduct electricity from an inside to an outside of the battery case. The negative terminal unit is formed of copper (Cu) or a Cu alloy and includes a fixing member fixing the battery case to the current collector terminal. The method includes ultrasonically bonding an external terminal formed of aluminum (Al) or an Al alloy to the fixing member of the negative terminal unit, and heating the external terminal that has undergone the ultrasonic bonding to form a diffusion-bonded portion and an intermolecular-bonded portion in a bonded surface of the external terminal and the fixing member of the negative terminal unit.

Another aspect of the present disclosure is a method for manufacturing a lithium-ion rechargeable battery. The lithium-ion rechargeable battery includes a power generating element, a battery case accommodating the power generating element, a current collector terminal electrically connected to a negative electrode body of the power generating element, and a negative terminal unit connected to the current collector terminal and configured to conduct electricity from an inside to an outside of the battery case. The negative terminal unit is formed of copper (Cu) or a Cu alloy and includes a fixing member fixing the battery case to the current collector terminal. The method includes connecting a connection member formed of Cu or a Cu alloy to the fixing member of the negative terminal unit, ultrasonically bonding an external terminal formed of aluminum (Al) or an Al alloy to the connection member, and heating a bonded surface of the external terminal and the connection member, which is obtained by the ultrasonic bonding, to form a diffusion-bonded portion and an intermolecular-bonded portion.

Another aspect of the present disclosure is a lithium-ion rechargeable battery that includes a power generating element, a battery case accommodating the power generating element, a current collector terminal electrically connected to a negative electrode body of the power generating element, a negative terminal unit connected to the current collector terminal and configured to conduct electricity from an inside to an outside of the battery case, the negative terminal unit being formed of copper (Cu) or a Cu alloy and including a fixing member fixing the battery case to the current collector terminal, and an external terminal formed of aluminum (Al) or an Al alloy bonded to the fixing member. The fixing member of the negative electrode unit and the external terminal include a bonded surface including a diffusion-bonded portion and an intermolecular-bonded portion.

Another aspect of the present disclosure is a lithium-ion rechargeable battery that includes a power generating element, a battery case accommodating the power generating element, a current collector terminal electrically connected to a negative electrode body of the power generating element, a negative terminal unit connected to the current collector terminal and configured to conduct electricity from an inside to an outside of the battery case, the negative terminal unit being formed of copper (Cu) or a Cu alloy and including a fixing member fixing the battery case to the current collector terminal, a connection member connected to the fixing member and formed of Cu or a Cu alloy, and an external terminal bonded to the connection member and formed of aluminum (Al) or an Al alloy. The connection member and the external terminal include a bonded surface including a diffusion-bonded portion and an intermolecular-bonded portion.

Another aspect of the present disclosure is an assembled battery including the lithium-ion rechargeable battery. The assembled battery includes a busbar laser-welded to the external terminal.

Other features and aspects will be apparent from the following detailed description, the drawings, and the claims.

### BRIEF DESCRIPTION OF THE DRAWINGS

FIG. 1 is an exploded perspective view of an assembled battery including a stack of lithium-ion rechargeable batteries, or cell batteries.

FIG. 2 is a plan view of an assembled battery 1.

FIG. 3 is a schematic diagram showing an internal structure of a lithium-ion rechargeable battery.

FIG. 4 is a partial exploded perspective view of a negative terminal unit.

FIG. 5 is a schematic cross-sectional view showing the vicinity of the negative terminal unit shown in FIG. 3.

FIGS. 6A, 6B, and 6C are schematic diagrams showing the principle of solid-phase bonding of the present embodiment where FIG. 6A shows a state before bonding, FIG. 6B shows a state after ultrasonic bonding, and FIG. 6C shows a state after diffusion bonding.

FIG. 7 is a flowchart showing steps of manufacturing the assembled battery 1 in the present embodiment.

FIG. 8 is a flowchart showing the procedure of solid-phase bonding in the manufacturing method of the present embodiment.

FIG. 9 is a schematic diagram showing a state before the ultrasonic bonding step in the manufacturing method of the present embodiment.

FIG. 10 is a schematic diagram showing a state during the ultrasonic bonding step in the manufacturing method of the present embodiment.

FIG. 11A a plan view of a schematic diagram in which a busbar is fitted after the ultrasonic bonding step in the manufacturing method of the present embodiment, and FIG. 11B is a side view of the schematic diagram.

FIG. 12A a plan view of a schematic diagram showing a state during the diffusion bonding step in the manufacturing method of the present embodiment, and FIG. 12B is a side view of the schematic diagram.

FIG. 13 is a schematic diagram showing a state during the diffusion bonding step in the manufacturing method of the present embodiment.

FIG. 14 is a schematic diagram showing a state after the diffusion bonding step in the manufacturing method of the present embodiment.

FIG. 15 is a schematic diagram of a light receiving port arranged on an external terminal of the present embodiment.

FIG. 16 is an exploded perspective view of a negative terminal unit in a second embodiment.

FIG. 17 is a schematic cross-sectional view showing the vicinity of the negative terminal unit of the second embodiment.

FIG. 18 is a plan view of an assembled battery 1 of the second embodiment.

FIG. 19A is a plan view of a schematic diagram in which an external terminal is ultrasonic-bonded to a connection member in the second embodiment, and FIG. 19B is a side view of the schematic diagram.

FIG. 20A is a plan view of a schematic diagram showing a busbar fitted to the external terminal in the second embodiment, and FIG. 20B is a side view of the schematic diagram.

FIG. 21 is a schematic diagram of laser welding in a manufacturing method of the second embodiment.

FIG. 22 is a cross-sectional view of a terminal unit of a conventional lithium-ion rechargeable battery.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

Examples of a lithium-ion rechargeable battery, a method for manufacturing a lithium-ion rechargeable battery, and an assembled battery of lithium-ion rechargeable batteries according to the present disclosure will be described in embodiments of a cell battery 10 of a lithium-ion rechargeable battery, an assembled battery 1 of lithium-ion rechargeable batteries, and a method for manufacturing the cell battery 10 and the assembled battery 1.

### First Embodiment

### Configuration of Embodiment

Assembled Battery 1

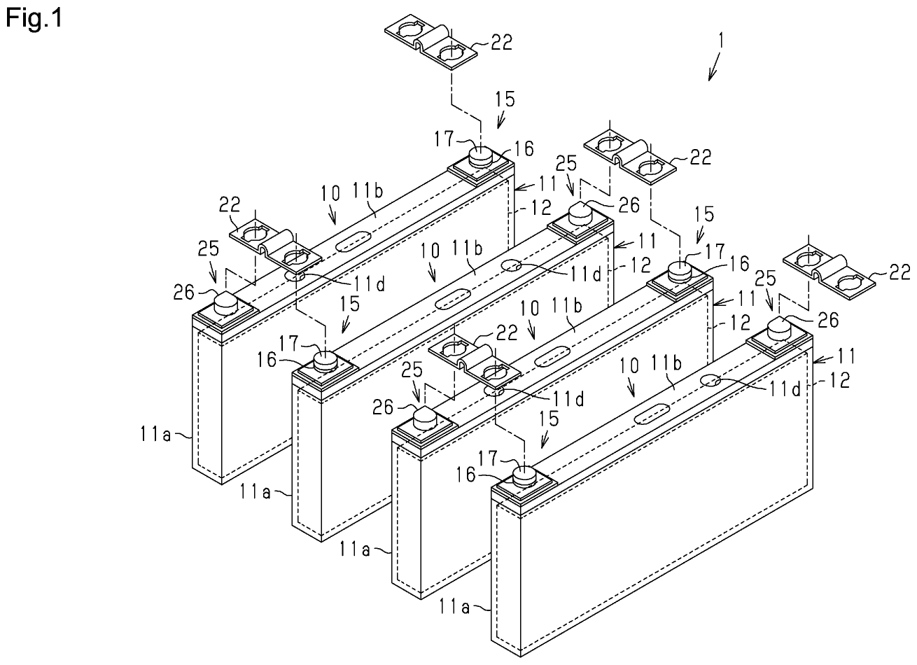

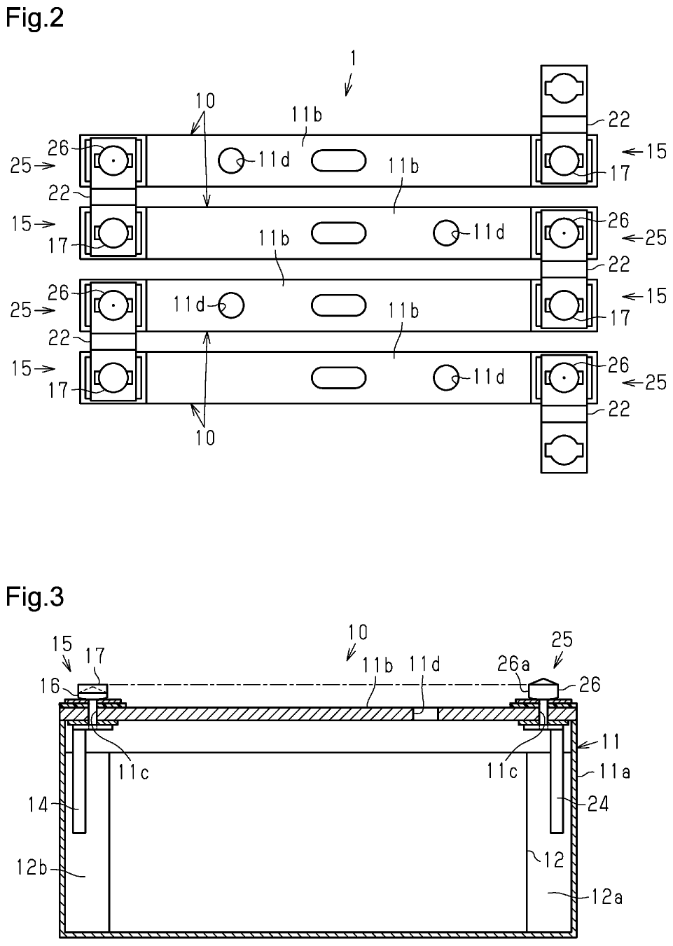

FIG. 1 is an exploded perspective view of the assembled battery 1 including a stack of lithium-ion rechargeable cell batteries 10. FIG. 2 is a plan view of the assembled battery 1. In the description of the present embodiment, the upward direction shown in FIG. 1 refers to the upper side.

FIG. 2 shows an on-board lithium-ion rechargeable battery pack that includes the assembled battery 1 formed by stacking multiple (here, four) cell batteries 10, which are battery cells of lithium-ion rechargeable battery. As shown in FIG. 1, each cell battery 10 includes a rectangular-plate-shaped battery case 11 accommodating a power generating element 12, a lid arranged on an upper portion of the battery case 11, and a negative terminal unit 15 and a positive terminal unit 25 arranged on opposite ends of the lid. The cell batteries 10 are stacked on and fixed to one another so that the negative terminal units 15 alternate with the positive terminal units 25. A negative external terminal 17 is electrically connected to a positive fixing member 26 by a busbar 22.

Cell Battery 10

FIG. 3 is a schematic cross-sectional view showing an inner structure of the cell battery 10. The power generating element 12 accommodated in the battery case 11 is formed by rolling an elongated positive sheet, an elongated negative sheet, and separators sandwiching the positive sheet and the negative sheet to insulate the positive sheet from the negative sheet, which are not shown in the drawings. The rolled body is accommodated in the battery case 11. A positive tab 12a is arranged at the positive electrode side, and a negative tab 12b is arranged at the negative electrode side.

Battery Case 11

The battery case 11 includes a body 11a and a lid 11b. The body 11a has the shape of a rectangular box having an opening at the upper side. The lid 11b is fitted to the opening of the body 11a and welded to the body 11a to seal the opening. Connection holes 11c extend through opposite ends of the lid 11b to allow a negative fixing member 16 and the positive fixing member 26 to extend through. The lid 11b includes an inlet 11d arranged at a central position to allow an electrolytic solution to be injected into the battery case 11. After the electrolytic solution is injected, the inlet 11d is sealed.

Positive Sheet

The positive sheet includes a positive core and a positive composite material layer.

The positive core is a sheet having a thickness of approximately 15 μm that forms a core of the positive sheet and allows electricity to flow to a positive active material and a conductive material. A passivation coating is formed on a surface of the positive core so that the positive core is used without dissolving in the positive electrode. The positive core is, for example, an Al foil or an Al alloy foil. The positive core and the positive tab 12a integrally conduct electricity.

The materials forming the positive composite material layer include a positive active material, a positive conductive material, and a positive binder. The positive active material discharges lithium ions during charging and adsorbs lithium ions during discharging. To facilitate the flow of electricity, the positive active material is mixed with a conductive material to form the positive sheet. An example of the materials forming the positive composite material layer is a metal oxide containing lithium and includes an electrode active material of a layered crystal for the positive electrode such as LiMnO2, LiCoO2, LiCo1-xNixO2, LiNiO2, V2O5, or Nb2O5.

Negative Sheet

The negative sheet includes a negative core and a negative composite material layer.

The negative core is a sheet having a thickness of approximately 10 μm that forms a core of the negative sheet and allows electricity to flow to a negative active material. The negative core is, for example, a copper foil. The negative core and the negative tab 12b integrally conduct electricity.

The materials forming the negative composite material layer include a negative active material, a negative binder, and a negative dispersion stabilizer. A paste of the materials is applied to the negative core to form, for example, a layer having a thickness of 40 μm on each surface in the present embodiment. The negative active material is, for example, graphite powder.

Separator

The separator is a sheet formed of a resin such as polypropylene (PP) or polyethylene (PE) and having a thickness of approximately 20 μm. The sheet is porous to allow exchanges of ions in the electrolytic solution while insulating the positive sheet from the negative sheet.

Negative Current Collector Terminal 14 and Positive Current Collector Terminal 24

As described above, the positive tab 12a and the negative tab 12b of the power generating element 12 are arranged at opposite ends of the inner portion of the battery case 11. The positive tab 12a is electrically connected to a positive current collector terminal 24. The negative tab 12b is electrically connected to a negative current collector terminal 14. The positive tab 12a and the positive core are formed of the same Al-base metal. The positive current collector terminal 24 connected to the positive tab 12a is also formed of the same Al-base metal. The negative tab 12b and the negative core are formed of the same Cu-base metal. The negative current collector terminal 14 connected to the negative tab 12b is also formed of the same Cu-base metal.

Negative Terminal Unit 15

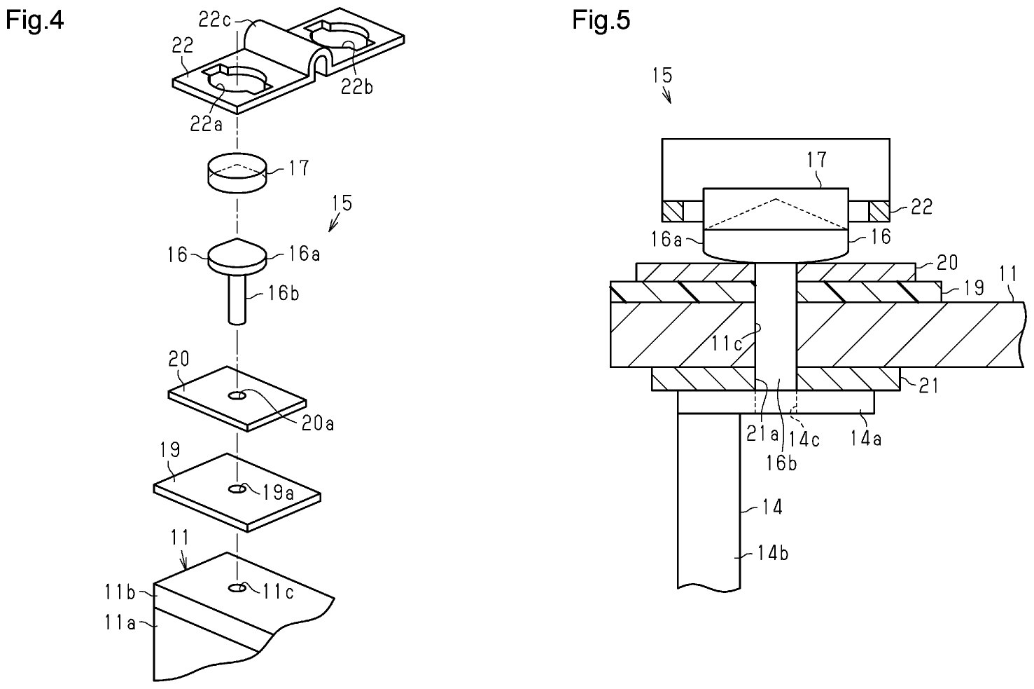

FIG. 4 is an exploded perspective view of the negative terminal unit 15. FIG. 5 is a schematic cross-sectional view showing the vicinity of the negative terminal unit 15 shown in FIG. 3. The negative terminal unit 15 will be described with reference to FIGS. 4 and 5.

Negative Fixing Member 16

A connection hole 11c extends through an end of the lid 11b, which is located at the upper portion of the battery case 11, to connect the inside and the outside of the battery case 11. The negative terminal unit 15 includes the negative fixing member 16 for swaging. The negative fixing member 16 is formed of Cu and includes a head 16a and a leg 16b. The head 16a is substantially disc-shaped and has a conical top. The head 16a includes a curved lower surface so that the thickness is reduced from the center to the peripheral edge. The leg 16b is rod-shaped and extends downward from the center of the head 16a.

An insulator 19 includes a hole 19a at the center to allow for insertion of the leg 16b of the negative fixing member 16. The insulator 19 is a resin insulation member that is rectangular and flat to insulate the battery case 11 from the negative fixing member 16. Although not shown in the drawings, the battery case 11 is insulated from the negative fixing member 16. A washer 20 is a member of a metal plate that is slightly smaller than the insulator 19 and includes a hole 20a through which the leg 16b of the negative fixing member 16 is inserted. The washer 20 is disposed between the head 16a of the negative fixing member 16 and the insulator 19. When a high pressure is applied to the head 16a of the negative fixing member 16, the washer 20 distributes the pressure so that the head 16a of the negative fixing member 16 will not sink into the elastic insulator 19.

External Terminal 17

An external terminal 17 is substantially disc-shaped and has the same diameter as the head 16a of the negative fixing member 16. The external terminal 17 includes a lower surface shaped in conformance with the top of the negative fixing member 16 so that the lower surface is in tight contact with the top of the negative fixing member 16. The external terminal 17 is a member formed of an Al-base material and mechanically and electrically bonded to the top of the negative fixing member 16 formed of a Cu-base material through solid phase bonding. This point will be described in detail later. The busbar 22 is a flat member that electrically connects the negative external terminal 17 to the positive terminal unit 25 and is formed of an Al-base material. The busbar 22 includes fitting holes 22a and 22b located at opposite ends. The external terminal 17 that is bonded to the negative fixing member 16 is fitted to the fitting hole 22a and welded to the busbar 22 formed of the same Al-base material. A head 26a (refer to FIG. 3) of the positive fixing member 26 is fitted to the fitting hole 22b and welded to the busbar 22.

Assembly of Negative Terminal Unit 15

As shown in FIG. 3, the negative current collector terminal 14 is formed of a Cu-base material and includes a leg 14b electrically connected to the negative tab 12b. As shown in FIG. 5, the negative current collector terminal 14 includes a disc-shaped horizontal head 14a. A fixing hole 14c extends through a center of the head 14a. The diameter of the fixing hole 14c is substantially the same as the diameter of the leg 16b of the negative fixing member 16. The leg 16b of the negative fixing member 16 is press-fitted and swaged to the fixing hole 14c of the head 14a. A gasket 21 is disposed between the battery case 11 and the head 14a of the negative current collector terminal 14 to maintain insulation and hermetic seal.

As shown in FIG. 4, to assemble the negative terminal unit 15, the leg 16b of the negative fixing member 16 is inserted into the connection hole 11c of the battery case 11 through the hole 20a of the washer 20 and the hole 19a of the insulator 19. As shown in FIG. 5, the distal end of the leg 16b of the negative fixing member 16, which is exposed from the connection hole 11c of the battery case 11, is inserted into a hole 21a of the gasket 21 and press-fitted to the fixing hole 14c in the head 14a of the negative current collector terminal 14 via the gasket 21. When the lower surface of the head 14a of the negative current collector terminal 14 is fixed, the head 16a of the negative fixing member 16 is pushed by a large force to elastically deform the leg 16b of the negative fixing member 16, and the gasket 21 is in tight contact to hermetically seal the inside of the battery case 11 from the outside. Electricity from the negative current collector terminal 14 is conducted from the inside to the outside of the battery case 11 via the negative fixing member 16. The negative current collector terminal 14 and the negative fixing member 16 are insulated from the battery case 11.

Bonding of External Terminal 17

The external terminal 17 formed of Al and an Al Alloy is bonded to the head 16a of the negative fixing member 16 formed of Cu and a Cu alloy. Hereafter, Al and an Al alloy are referred to as “Al-base,” and Cu and a Cu alloy are referred to as “Cu-base.” This point will be described in detail.

Positive Terminal Unit 25

As shown in FIG. 3, the positive terminal unit 25 and the negative terminal unit 15 basically have the same configuration. The difference is that the positive fixing member 26 and the positive current collector terminal 24 including a washer are formed of the same Al-base metal as the positive tab 12a.

In addition, the positive fixing member 26 has a contour that is similar to the negative fixing member 16 and the external terminal 17 that are integrated with each other. When the busbar 22 is fitted and welded, as indicated by the single-dashed line shown in FIG. 3, the upper end of the positive fixing member 26 is level with the upper end of the negative fixing member 16 and the external terminal 17. Therefore, as shown in FIG. 1, when the negative external terminal 17 is fitted to the fitting hole 22a of the busbar 22 and the head 26a of the positive fixing member 26 is fitted to the fitting hole 22b, the busbar 22 is attached horizontally. In this case, since the Al-base busbar 22 is connected to the Al-base negative external terminal 17 and the positive fixing member 26, the connection is readily performed.

### Operation of Present Embodiment

### Principle of Solid-Phase-Bonding of Present Embodiment

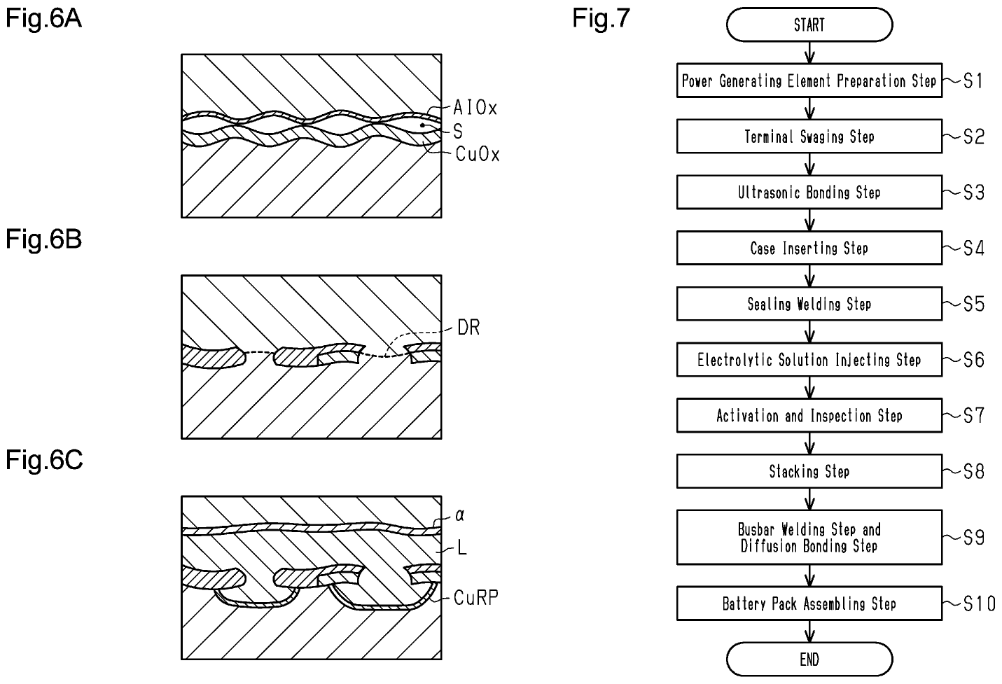

FIGS. 6A to 6C are schematic diagrams showing the principle of bonding of the present embodiment where FIG. 6A shows a state before the bonding, FIG. 6B shows a state after ultrasonic bonding, and FIG. 6C shows a state after diffusion bonding. The principle of the solid-phase bonding of the present embodiment will now be described with reference to FIGS. 6A to 6C.

As shown in FIG. 6A, it is generally difficult to bond an Al-base metal to a Cu-base metal through liquid phase bonding such as welding.

The stable aluminum oxide coating AlOx formed on a surface of the Al-base metal has a very high thermal stability and hinders diffusion bonding of aluminum. Also, a copper oxide coating CuOx is formed on a surface of the Cu-base metal.

The melting point of aluminum is approximately 660° C. The melting point of copper is approximately 1085° C. The difference in the melting point is greater than or equal to 300° C. Although the melting points of an Al alloy and a Cu alloy vary depending on compositions, the difference in the melting point is greater than or equal to a few hundred degrees. The melting points that greatly differ from each other hinder welding. If welding is performed, the heat of the welding causes a reaction that produces an intermetallic compound having a low mechanical strength due to an inclination of compositions of Al and Cu in the bonded interface. This lowers bonding strength.

In contrast, solid phase bonding is not likely to have such a shortcoming. The term “solid phase bonding” refers to bonding of solid-phase materials without using braze at the melting points of the base materials or below. Japanese Industrial Standards (JIS) defines “solid phase bonding” as “a bonding process that applies pressure minimizing plastic deformation to base materials that are in tight contact with each other at the melting points of the base materials or below so that diffusion of atoms generated between the bonded surfaces is utilized to bond the materials.”

Solid phase bonding includes cold pressure bonding, diffusion bonding, ultrasonic bonding, and friction bonding.

The term “cold pressure bonding” refers to a static process and room-temperature pressure bonding that mainly uses pressure energy without using thermal energy. Therefore, cold pressure bonding needs a high pressure and has a long duration.

The term “diffusion bonding” refers to high-temperature pressure bonding that generally applies pressure and heat to base materials without melting the base materials so that atoms in a bonded interface diffuse across the bonded surface to form a metallurgically complete bonded portion.

When pressure and heat are applied to the base materials including oxide coatings, the oxide coatings are broken at the same time as contact portions are formed as a result of plastic deformation. When the temperature and the pressure are maintained, creep deformation and atom diffusion occur in the vicinity of bonded interface and shrink a void. Concurrently, breakage and resolution of the oxide coatings advance. As a result, the clean metal surfaces increase, and the atomic arrangement of the bonded interface becomes closer to a crystal grain boundary. As time elapses, the crystal grains grow across the bonded interface and become an integrated metal having a high mechanical strength and conductivity.

Diffusion bonding is implemented by maintaining two materials in tight contact with each other at a high temperature and a high pressure. (1) When an aluminum oxide film and a copper oxide film are in close contact with each other and are heated at a high pressure, the aluminum oxide film and the copper oxide film take in oxygen from a gap to grow and come into closer contact with each other. (2) The interface is formed in a portion where compression stress or the like is applied to break the aluminum oxide layer, which has a large thermal expansion coefficient, and allow for direct contact of Al atoms with Cu atoms. (3) Diffusion and transfer of the Al atoms advance in the interface to form a bonded layer and complete the diffusion bonding process.

Diffusion bonding needs a high pressure and heat for a long duration. In particular, the stable aluminum oxide coating AlOx formed on the surface of the Al-base metal hinders the bonding. Since diffusion bonding has a long duration and requires a strict process control, which results in a costly material, it is generally considered that diffusion bonding is unsuitable for mass production.

As shown in FIGS. 6A to 6C, the diffusion bonding of the present embodiment differs from a general diffusion bonding in that ultrasonic bonding is performed and then diffusion bonding is performed using only heat to obtain the same result as the general diffusion bonding. This point will be described later.

Friction bonding obtains a large amount of energy from friction. However, since friction bonding requires production of great friction between members, a large device is used. In addition, it is difficult for a rotary body to produce a uniform friction heat between a central part and a peripheral edge.

As compared to diffusion bonding, ultrasonic bonding as described in, for example, Japanese Laid-Open Patent Publication No. 2017-228418, applies energy with mechanically dynamic motion. Thus, ultrasonic bonding is performed in a short time by a relatively small ultrasonic bonding machine applying relatively small heat and low pressure. In addition, as compared to friction bonding, the ultrasonic bonding machine is simpler than a friction bonding device. In this regard, as described in Japanese Laid-Open Patent Publication No. 2017-228418, ultrasonic bonding may be used to perform solid phase bonding. Such ultrasonic bonding ensures a predetermined mechanical strength and a certain conductivity. However, ultrasonic bonding is molecular bonding and thus is inferior in conductivity to diffusion bonding, which is atomic bonding.

In solid phase bonding of the present embodiment, when the aluminum oxide coating AlOx and the copper oxide coating CuOx exist as shown in FIG. 6A, ultrasonic bonding is performed to fill the space S by plastic deformation in an ultrasonic bonding step as shown in FIG. 6B. The stable oxide films are broken to form a diffusion path DR so that intermolecular bonds are formed. In this state, a predetermined mechanical strength is obtained, and a certain electrical conductivity is obtained.

Further, in the present embodiment, as shown in FIG. 6C, a diffusion bonding step is performed using the heat of laser welding to diffuse atoms in the interface in which intermolecular bonds are formed by thermal energy to generate reaction diffusion similar to an interface of diffusion bonding. In the ultrasonic bonding step, the stable oxide films have been broken to form the diffusion path DR including molecular bonding. Thus, without applying a high pressure, diffusion bonding is performed using only extra heat produced during laser welding. As a result, an interface a including a-phase particularly containing a large number of elements of aluminum is formed at the aluminum side, and an interface CuRP particularly containing a large number of elements of copper is formed at the copper side. An intermediate layer L is also formed. In the intermediate layer L, aluminum and copper are bonded in accordance with the inclination of compositions. The process of diffusion bonding in which each is atomically bonded is completed.

As described above, in the present embodiment, solid phase bonding is divided into two steps, namely, the ultrasonic bonding step and the diffusion bonding step. This eliminates the need for a high pressure and obtains high mechanical strength and high electrical conductivity by relatively easy steps within a short time.

### Manufacturing Method of Lithium-Ion Rechargeable Battery in Present Embodiment

Manufacturing Step of Assembled Battery 1

FIG. 7 is a flowchart showing steps of manufacturing the assembled battery 1 in the present embodiment.

Power Generating Element Preparation Step (S1)

The power generating element preparation step (S1) is executed. The power generating element 12 has a known structure obtained by rolling an elongated positive sheet, an elongated negative sheet, and a separator sandwiching and insulating the positive sheet and the negative sheet into a shape. To briefly describe, a paste of a positive composite material layer is applied to a positive core to form the positive sheet, and a paste of a negative composite material layer is applied to a negative core to form the negative sheet. Then, the positive sheet and the negative sheet are insulated by a separator. The positive sheet, the negative sheet, and the separator are stacked to form three layers, rolled and compressed into a shape, and then wrapped by an insulator to be insulated. In the present embodiment, as shown in FIG. 3, the Al-base positive tab 12a and the Cu-base negative tab 12b, which are located at opposite ends of the power generating element 12, are respectively welded to the Al-base positive current collector terminal 24 and the Cu-base negative current collector terminal 14.

Terminal Swaging Step (S2)

Next, the terminal swaging step (S2) is executed. The positive fixing member 26 swages and fixes the positive current collector terminal 24 to a predetermined position of the lid 11b of the battery case 11. The negative fixing member 16 swages and fixes the negative current collector terminal 14 to a predetermined position of the lid 11b of the battery case 11. Since the above steps are similar to each other, the terminal swaging step (S2) will be described based on the negative terminal unit 15 as an example with reference to FIGS. 4 and 5. As shown in FIG. 5, when the connection hole 11c that is open in the predetermined position of an inner end of the lid 11b of the battery case 11 is aligned with the fixing hole 14c extending in the center of the disc-shaped head 14a of the negative current collector terminal 14, the lid 11b and the negative current collector terminal 14 are temporarily fixed, and the disc-shaped head 14a of the negative current collector terminal 14 is supported by a jig from the lower side.

As shown in FIG. 4, the distal end of the leg 16b of the negative fixing member 16 is inserted through the hole in the washer 20 and the hole 19a in the insulator 19 into the connection hole 11c of the battery case 11. The distal end of the leg 16b of the negative fixing member 16 is inserted into the fixing hole 14c of the negative current collector terminal 14. The top of the negative fixing member 16 is fixed by a jig and swaged by a swage (not shown) with a large force from the upper side. At this time, the disc-shaped head 14a of the negative current collector terminal 14 is supported from the lower side, so that the leg 16b of the negative fixing member 16 plastically deforms in the thickness-wise direction and comes into tight contact with the wall surface of the negative current collector terminal 14 defining the fixing hole 14c. The negative fixing member 16 is insulated from the battery case 11 in the connection hole 11c by an insulation member (not shown). As a result, the negative current collector terminal 14 is firmly mechanically joined to the battery case 11. Also, the negative current collector terminal 14 is firmly mechanically fixed to the negative fixing member 16 and obtains electrical conductivity. Subsequently, the negative current collector terminal 14 is welded to the negative fixing member 16 so that the mechanical strength and the electric conductivity are increased. In this case, the negative current collector terminal 14 and the negative fixing member 16 are both formed of a Cu-base material. Thus, welding is easily and completely performed.

The same steps apply to the positive terminal unit 25 except that the material is different and is aluminum and that, as shown in FIG. 3, the head 26a of the positive fixing member 26 has a greater thickness than the head 16a of the negative fixing member 16. The positive terminal unit 25 will not be described in detail.

Ultrasonic Bonding Step (S3)

Next, the ultrasonic bonding step (S3) is executed. The ultrasonic bonding step (S3) is a step of fixing the negative external terminal 17 to the upper surface of the head 16a of the negative fixing member 16 through solid phase bonding.

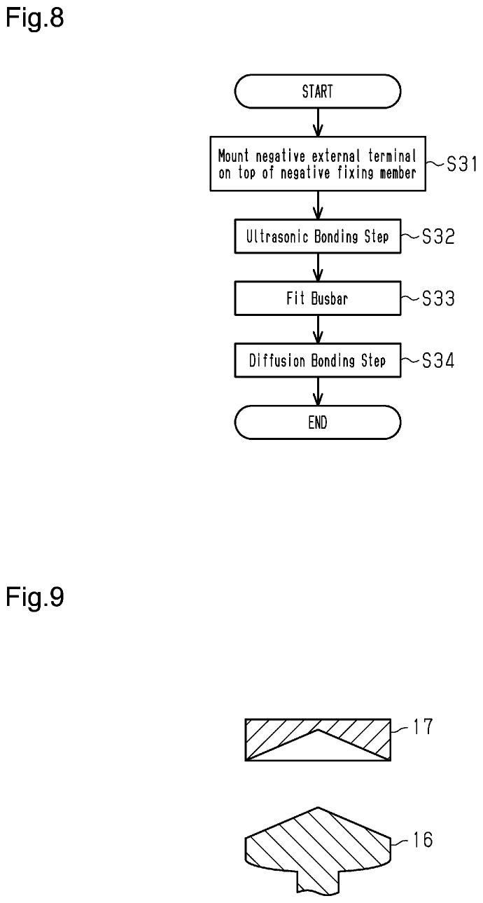

FIG. 8 is a flowchart showing solid phase bonding that includes the ultrasonic bonding step and the diffusion bonding step in the manufacturing method of the present embodiment. The flowchart shown in FIG. 8 will be referred to in the description below.

Ultrasonic Bonding Step (S32)

As shown in FIG. 9, the negative external terminal 17 is mounted on the top of the negative fixing member 16 (S31). The top of the negative fixing member 16 is conical. The lower surface of the negative external terminal 17 is shaped in conformance with the top of the negative fixing member 16 so as to come into tight contact with the top of the negative fixing member 16.

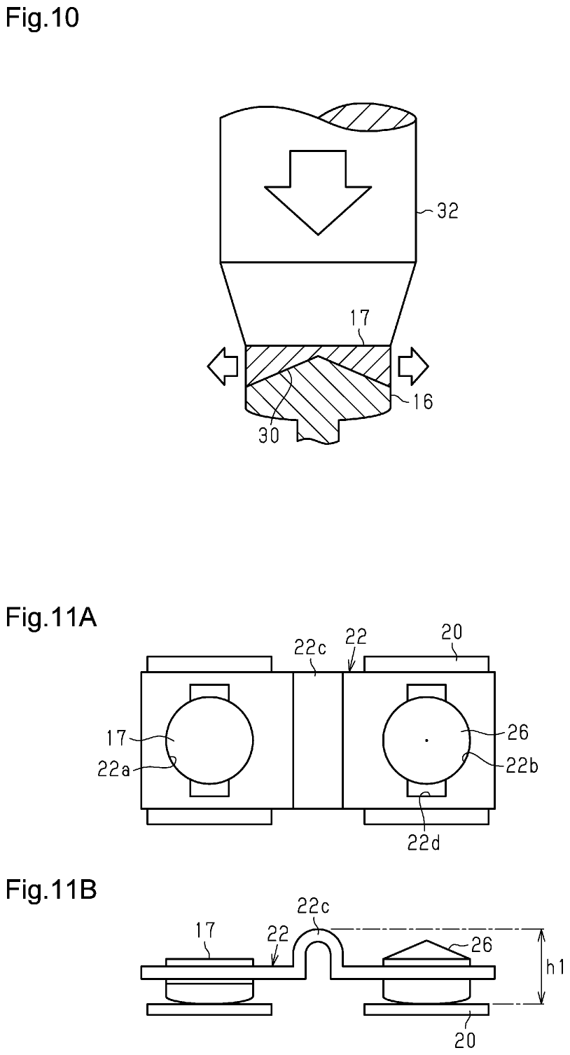

As shown in FIG. 10, the ultrasonic bonding step is executed so that an ultrasonic bonding machine 32 contacts and presses the negative external terminal 17, which is mounted on the top of the negative fixing member 16, from the upper side to perform the ultrasonic bonding step (S32).

In the present embodiment, the bonding condition for ultrasonic bonding is, for example, that an applied load is 100 to 500 N, oscillation duration is 0.2 to 0.8 s, and a frequency is 10 to 40 kHz. In addition, an energy amount is 250 to 400 J, preferably, 268 J or greater, and more preferably, 292 J or greater. In addition, a peak output is 700 to 1400 W, preferably, 764 W or greater.

The resulting pressure capacity is greater than or equal to 3 Mpa.

Case Inserting Step (S4)

Referring back to FIG. 7, the manufacturing steps of the assembled battery 1 in the present embodiment after the ultrasonic bonding step (S3) will be described. As described above, after the power generating element 12, the positive terminal unit 25, and the negative terminal unit 15 are fixed to the lid 11b of the battery case 11, the case inserting step (S4) is executed to insert the lid 11b into the body 11a of the battery case 11.

Sealing Welding Step (S5)

After the case inserting step (S4), the sealing welding step (S5) is executed to seal the body 11a and the lid 11b of the metal battery case 11 by laser welding.

Electrolytic Solution Injecting Step (S6)

After the sealing welding step (S5), the battery case 11 is heated so that the inside of the battery case 11 is sufficiently dried. Subsequently, the electrolytic solution injecting step (S6) is executed to inject an electrolytic solution from the inlet 11d of the lid 11b of the battery case 11 and then seal the inlet 11d.

Activation and Inspection Step (S7)

Completion of the electrolytic solution injecting step (S6) completes the cell battery 10. The activation and inspection step (S7) is executed to execute an activation step such as formation of a solid electrolyte interphase (SEI) coating and then execute an inspection step such as inspection of battery capacity, battery internal resistance, and self-discharging to remove a defective cell battery 10.

Stacking Step (S8)

The stacking step (S8) is executed so that, as shown in FIGS. 1 and 2, multiple (four, in the present embodiment) cell batteries 10 that have passed the activation and inspection step (S7) are stacked on one another so that the positive terminal units 25 alternate with the negative terminal units 15 and are fixed by fixing members (not shown).

Busbar Welding Step and Diffusion Bonding Step (S9)

In the busbar welding step and the diffusion bonding step (S9), in parallel to the step of welding and fixing the busbar 22 to the external terminal 17 and the positive fixing member 26, atom diffusion equivalent to diffusion bonding is performed in a bonded surface 30 of the external terminal 17 with the negative fixing member 16.

The flowchart shown in FIG. 8 showing solid phase bonding that includes the ultrasonic bonding step and the diffusion bonding step in the manufacturing step of the present embodiment will be referred to in the description below.

Busbar Fitting (S33)

FIG. 11A is a plan view of a schematic diagram in which the busbar 22 is fitted to the external terminal 17 after the ultrasonic bonding step (S32) in the manufacturing method of the present embodiment. FIG. 11B is a side view of the schematic diagram. As shown in FIGS. 1 and 2, each busbar 22 is a member that electrically connects adjacent ones of the negative terminal units 15 and the positive terminal units 25 when the cell batteries 10 are stacked so that the negative terminal units 15 and the positive terminal units 25 are alternately opposed to one another.

As shown in FIG. 11, the busbar 22 is a thin flat member formed of a rectangular Al-base material as a whole. The busbar 22 includes a curved portion 22c at a longitudinal central position. The curved portion 22c traverses in the width-wise direction and is configured to absorb thermal expansion and contraction of the busbar 22. The fitting hole 22a is formed in one end of the busbar 22 to fit the negative external terminal 17. The fitting hole 22a is defined by an arc portion that joins to the negative external terminal 17 and cutaway portions 22d opposed to each other in a width-wise direction that is orthogonal to the longitudinal direction of the busbar 22. Each cutaway portion 22d is a rectangular gap and allows for dimensional adjustment between the external terminal 17 and the fitting hole 22a. Although the detail is not shown in the drawings, beveling (i.e. a groove) is formed in the circumferential edge of the fitting hole 22a. Beveling is a groove used when butt welding the external terminal 17. This allows for butt welding that forms complete penetration and fusion over the entire cross section so that the strength of the welded portion is greater than or equal to the strength of base materials.

The fitting hole 22b is formed in the other end of the busbar 22 to fit the positive fixing member 26. The structure of the fitting hole 22b is basically the same as that of the fitting hole 22a.

Diffusion Bonding Step (S34)

The diffusion bonding step (S34) is executed following the busbar fitting step (S33). In the present embodiment, the busbar welding step includes the diffusion bonding step (S34).

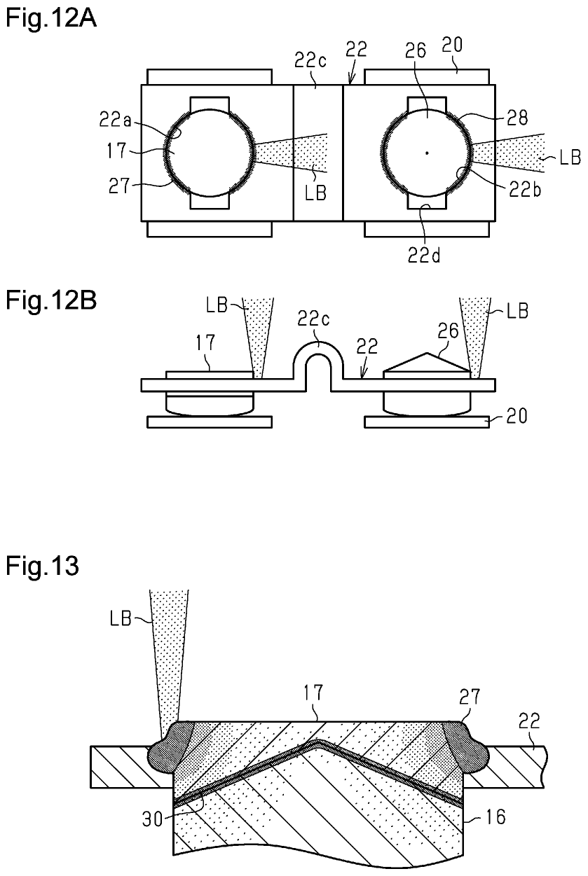

FIG. 12A is a plan view of a schematic diagram showing a state during the busbar welding and diffusion bonding step. FIG. 12B is a side view of the schematic diagram. FIG. 13 is a cross-sectional view of a schematic diagram showing a state during the busbar welding and diffusion bonding step.

Busbar Welding

When the negative external terminal 17 is fitted to the busbar 22 and is fixed by a jig as shown in FIGS. 11A and 11B, a laser welding machine emits a laser beam LB to the side surface of the negative external terminal 17 and the beveling of the bonded surface formed in the wall surface of the fitting hole 22a, to which the negative external terminal 17 is fitted as shown in FIGS. 12A, 12B, and 13. The laser welding machine has a known structure. In the laser welding, butt welding is performed so that the side surface of the negative external terminal 17 is entirely welded to the wall surface of the fitting hole 22a, to which the negative external terminal 17 is fitted. However, the welding does not necessarily have to be performed completely and may be merely substantially performed. Such butt welding performs a mechanically strong liquid phase bonding. However, in the present embodiment, a sufficient area is welded in order to maintain a sufficient electrical conductivity.

The welding is performed in the entire arc portion of the fitting hole 22a. In the same manner, the laser welding machine emits the laser beam LB to the side surface of the head 26a of the positive fixing member 26 and the beveling of the bonded surface formed in the wall surface of the fitting hole 22b, to which the positive fixing member 26 is fitted.

Diffusion Bonding

When welding the busbar 22, diffusion bonding is performed on the negative external terminal 17 using the heat of welding. In general, diffusion bonding is performed by applying a high pressure and heat. However, diffusion bonding of the present embodiment refers to a step performed using only the heat of welding the busbar 22 to the external terminal 17 on condition that ultrasonic bonding is performed beforehand.

That is, in the ultrasonic bonding step (S3), as shown in FIG. 6B, ultrasonic bonding breaks the stable oxide films and forms the diffusion path DR, so that the clean metals are in direct contact with each other and intermolecular bonds are formed. Therefore, by applying only heat, atoms diffuse in the diffusion path DR where molecular bonds are formed. As a result, diffusion of atoms equivalent to normal diffusion bonding is generated.

As shown in FIG. 13, in the busbar welding, the part irradiated with the laser beam LB receives heat from the laser beam LB, and the heat disperses in the Al-base external terminal 17 as conducted heat. The heat is transferred to the bonded surface 30 between the external terminal 17 and the negative fixing member 16 and excites atoms to disperse the atoms.

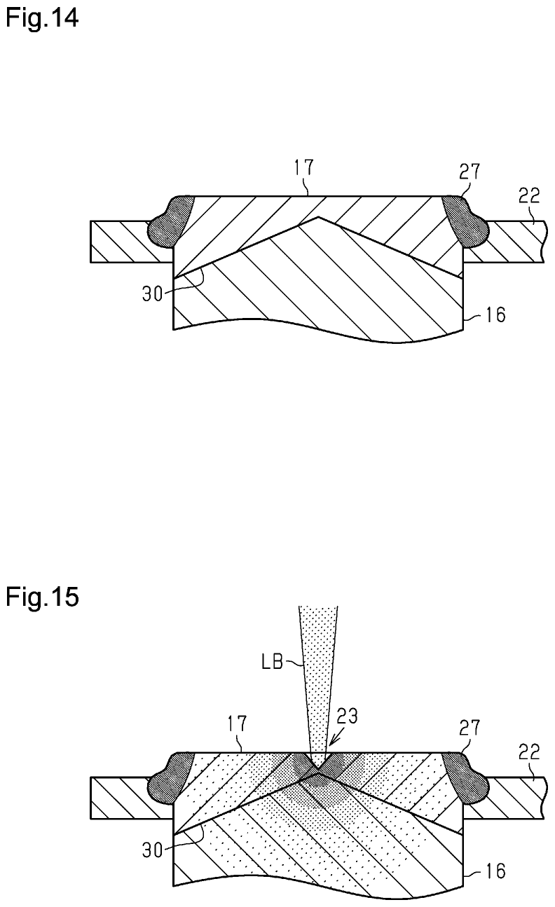

As a result, in the state shown in FIG. 14, a continuous structure that is atomically bonded is obtained as shown in FIG. 6C, and the bonded surface has disappeared. In this state, the diffusion bonding step is completed.

Battery Pack Assembling Step (S10)

Referring again to FIG. 7, the manufacturing step of the assembled battery 1 in the present embodiment will be described. When the busbar welding step and the diffusion bonding step (S9) are completed, accessories such as a controlling computer and sensors such as a thermometer, an ammeter, and a voltmeter are installed on the cell battery 10 and accommodated in a case and delivered as an on-board battery pack.

### Modified Examples of Embodiment

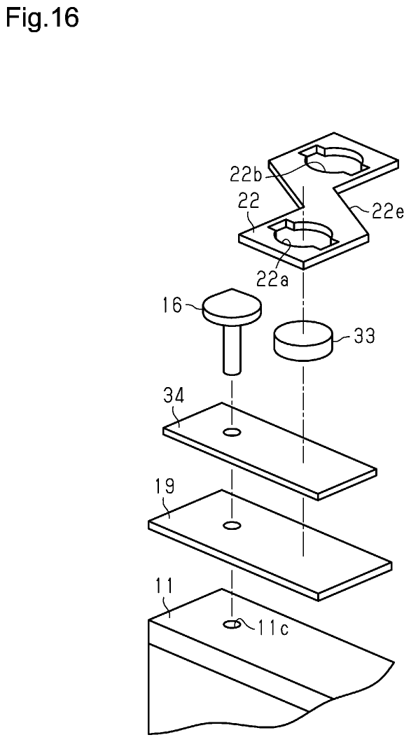

FIG. 15 is a cross-sectional view showing a further example of an external terminal 17. In the diffusion bonding step of the above embodiment, diffusion bonding is performed using the heat for welding the busbar 22 to the external terminal 17. Since diffusion and transfer of Al atoms occur at temperatures of around 400° C., it is generally considered that the residual heat of welding is sufficient. However, the energy for forming a welding portion 27 that welds the busbar 22 may not be equal to the energy for diffusion bonding the bonded surface 30 depending on the shape and material of the members. The amount of heat for welding the busbar 22 may be insufficient to perform diffusion bonding. Particularly, heat may not be sufficiently conducted to the central portion, which is separated by a relatively large distance from the welding portion 27. In this case, for example, the central portion of the upper surface of the external terminal 17 is bored to form a light receiving port 23. With this structure, a position close to the bonded surface 30 is irradiated with the welding laser beam LB, so that a sufficient amount of heat is applied to the bonded surface 30 and atoms sufficiently diffuse to perform diffusion bonding.

### Effects of Embodiment

(1) The Cu-base negative fixing member 16 is directly solid-phase-bonded to the Al-base external terminal 17 without using braze or a cladding material. This obtains mechanical strength and satisfactory electrical conductivity. Thus, resistance is lowered.

(2) The negative tab 12b and the negative current collector terminal 14, the negative current collector terminal 14 and the negative fixing member 16, and the external terminal 17 and the busbar 22 are formed of the same kind of metal and are weldable. Welding obtains a higher electrical conductivity than pressure bonding and the like. In addition, the negative fixing member 16 is solid-phase-bonded to the external terminal 17. This further increases the conductivity. The entire electrical bonding lowers the resistance value of the assembled battery 1.

(3) The busbar 22 is entirely formed of an Al-base material. This achieves weight reduction of the busbar 22.

(4) In addition to solid phase bonding performed by ultrasonic bonding, which demonstrates a certain strength and is mechanically strong bonding, solid phase bonding that is equivalent to diffusion bonding is performed so that diffusion of atoms integrates the interface and results in extremely strong fixing.

(5) The negative tab 12b is weldable to the negative current collector terminal 14, the negative current collector terminal 14 is weldable to the negative fixing member 16, and the external terminal 17 is weldable to the busbar 22. Changes caused by aging that occur in parts bonded using pressure bonding do not occur in the welded parts. In addition, the negative fixing member 16 and the external terminal 17 are solid-phase-bonded and thus are not prone to changes caused by aging. The entire electric bonding is resistant to changes caused by aging.

(6) FIG. 22 shows a conventional structure described in Patent Document 1 in which the negative electrode portion is mechanically fastened to the busbar by a screw or the like. In such a structure, a projection has a large height h0. As shown in FIG. 11B, in the present embodiment, since the busbar 22 is welded, a projection has a small height h1. This allows for a compact battery pack.

(7) There is no need for general diffusion bonding, which is performed by large equipment using a high pressure and heat and having a long duration. Instead, a relatively simple ultrasonic bonding machine and a general laser welding machine used for manufacturing batteries are used to perform bonding that is equivalent to general diffusion bonding. Thus, the bonding that obtains a satisfactory conductivity is performed with relatively simple devices in a short time.

(8) As shown in FIG. 5, the present embodiment has a simple structure as compared to a connection structure in which the negative electrode portion is mechanically fastened to the busbar by a screw or the like as in the prior art of Japanese Laid-Open Patent Publication No. 2017-228418, which is shown in FIG. 22. This reduces production costs.

(9) In the diffusion bonding of the present embodiment, as shown in FIG. 13, the heat of the laser beam LB is shared. This eliminates the waste of energy, the need for an additional separate step for diffusion bonding, and the need for separate time for diffusion bonding. Thus, the manufacturing is simplified.

(10) In addition, as shown in FIG. 15, the light receiving port 23 allows for heat adjustment and for complete diffusion bonding in the center of the external terminal 17.

### Second Embodiment

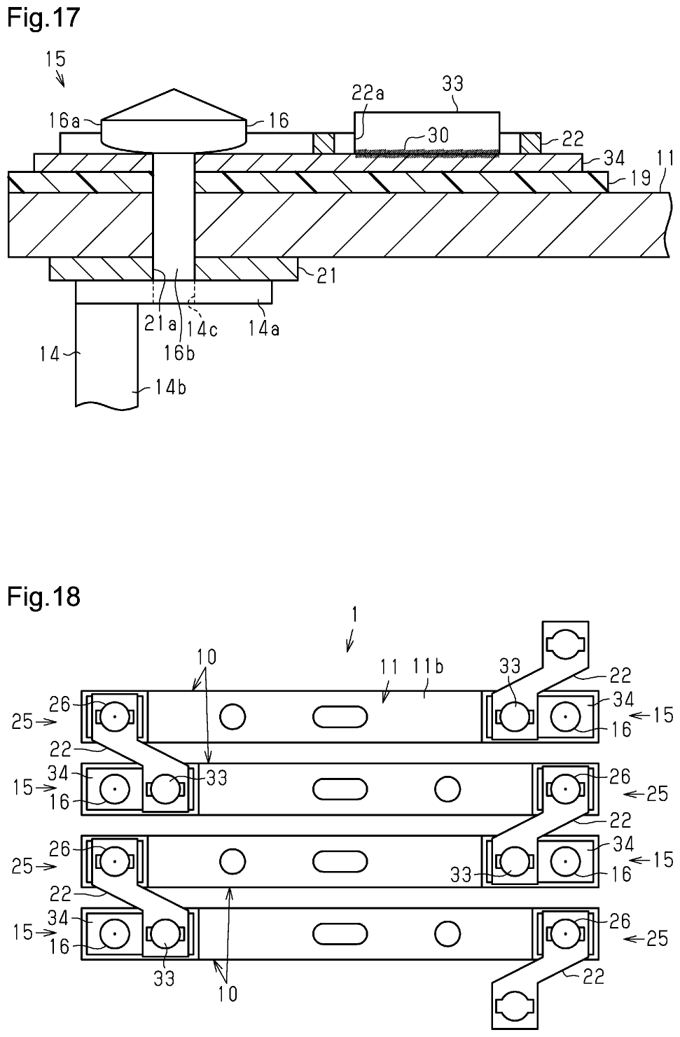

A second embodiment of the present disclosure will now be described. The second embodiment differs from the first embodiment in a connection structure of an external terminal 33. In the first embodiment, as shown in FIG. 5, the Al-base external terminal 17 is solid-phase-bonded to the top of the Cu-base negative fixing member 16. In the second embodiment, as shown in FIG. 17, a Cu-base flat connection member 34 extends from the Cu-base negative fixing member 16, a circular Al-base external terminal 33 is solid-phase-bonded to the connection member 34, and the busbar 22 is connected to the external terminal 33.

Negative Terminal Unit 15

FIG. 16 is an exploded perspective view of the second embodiment of a negative terminal unit 15. FIG. 17 is a schematic diagram showing the vicinity of the negative terminal unit 15 of the second embodiment.

As shown in FIG. 16, in the negative terminal unit 15 of the second embodiment, the insulator 19 is disposed on the lid 11b of the battery case 11 and extends closer to the center of the lid 11b than that of the first embodiment. The insulator 19 includes a hole 19a at a position aligned with the connection hole 11c of the battery case 11. The hole 19a and the connection hole 11c have the same diameter. The connection member 34 is disposed on the insulator 19. The connection member 34 is a flat plate-shaped member formed of a Cu-base metal. The connection member 34 is slightly smaller than the insulator 19 and has a structure that avoids short-circuiting to the battery case 11. A hole 34a extends through one end of the connection member 34 at a position aligned with the connection hole 11c of the battery case 11. The hole 34a and the connection hole 11c have the same diameter. The leg 16b of the negative fixing member 16 is inserted into the hole 34a. The other end of the connection member 34 includes a horizontal surface. The external terminal 33 is solid-phase-bonded to the horizontal surface. In the first embodiment, since the bottom of the external terminal 17 is solid-phase-bonded to the top of the negative fixing member 16, the bottom of the external terminal 17 includes a conical recess in conformance with the top of the negative fixing member 16. In the second embodiment, the external terminal 33 is solid-phase-bonded to the horizontal surface of the connection member 34. Thus, the bottom of the external terminal 33 includes a flat surface. More specifically, the external terminal 33 of the second embodiment has the form of a cylinder in which the height is less than the diameter. The busbar 22 is connected to the external terminal 33 of the second embodiment in the same manner as in the first embodiment.

As shown in FIG. 17, the leg 16b of the negative fixing member 16 is inserted through the gasket 21 and swaged to the head 14a of the negative current collector terminal 14. The structure is the same as that of the first embodiment and will not be described in detail.

External Terminal 33

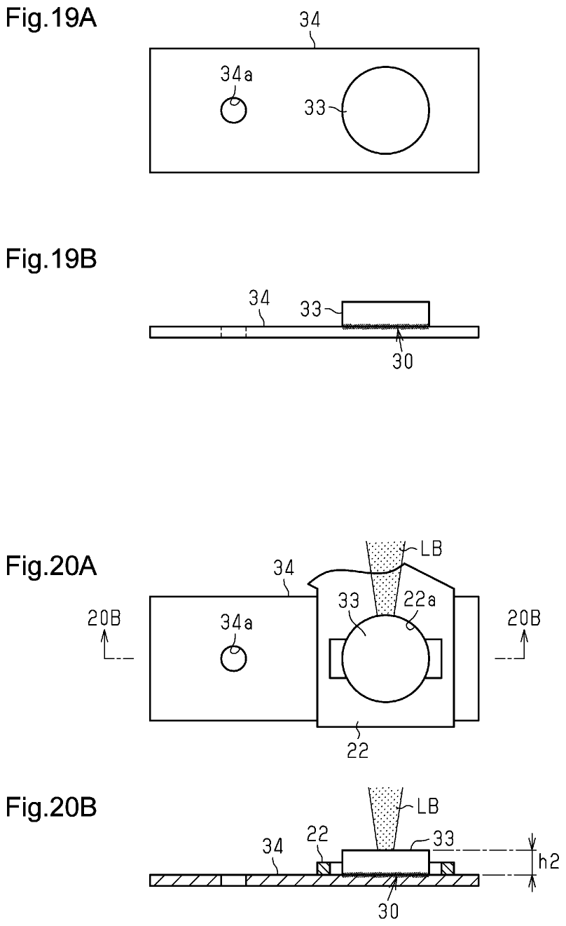

FIG. 19 is a schematic diagram of the external terminal 33 bonded to the connection member 34. Although the shapes differ from the first embodiment, the procedure for solid-phase-bonding the external terminal 33 to the connection member 34 is basically the same as the procedure for solid-phase-bonding the external terminal 17 to the top of the negative fixing member 16. That is, if the step “mount negative external terminal on top of negative fixing member” (S31) shown in FIG. 8 is replaced with a step “mount negative external terminal 33 on connection member 34,” steps S32 to S34 are commonly used.

In the first embodiment, the negative fixing member 16 is a conductive member forming the negative terminal unit 15 and also is a swaging member that fixes the negative terminal unit 15 to the battery case 11 and the negative current collector terminal 14. Therefore, the step “mount negative external terminal on top of negative fixing member” (S31) has to be subsequent to the swaging task. In the second embodiment, the step “mount negative external terminal 33 on connection member 34” may be executed either prior to or subsequent to the swaging task. That is, the step of the connection member 34 and the negative external terminal 33 may be separated from the steps of assembling the cell battery 10 and executed in parallel to the assembling steps. In this case, the ultrasonic bonding machine may perform simple ultrasonic bonding.

Busbar 22

FIG. 18 is a plan view of the assembled battery 1 of the second embodiment. In the first embodiment, the busbar 22 is rectangular plate formed of an Al-base material and includes the curved portion 22c at the central position. In the second embodiment, the external terminal 33 is not disposed above the negative fixing member 16 and is shifted toward the center of the battery case 11 because of the connection member 34. Therefore, as shown in FIG. 16, the busbar 22 includes two generally square portions, that is, a portion including the fitting hole 22a fitted to the negative external terminal 33 and a portion including the fitting hole 22b fitted to the positive fixing member 26. The busbar 22 further includes a connector 22e that diagonally connects the two portions to correspond to the misalignment of the negative external terminal 33 with the positive fixing member 26 when the cell batteries 10 are aligned with each other and stacked on one another. Thus, as shown in FIG. 18, when the negative external terminals 33 are coupled to the positive fixing members 26, the cell batteries 10 are aligned and stacked. To avoid the changing of the position of a positive fixing member 26 that serves as a positive electrode terminal of the assembled battery 1, the busbar 22 coupled to the positive fixing member 26 has the same shape as the busbar 22 of the first embodiment.

Welding of External Terminal 33 and Busbar 22

FIG. 19 is a schematic diagram of the external terminal 33 bonded to the connection member 34 of the second embodiment. FIG. 20A is a plan view of a schematic diagram showing the busbar fitted to the external terminal of the second embodiment. FIG. 20B is a side view of the schematic diagram.

As shown in FIG. 19, the external terminal 33 is ultrasonic-bonded to the connection member 34. Then, as shown in FIGS. 20A and 20B, the busbar 22 is fitted and welded to the external terminal 33. This step is similar to the busbar welding and diffusion bonding step (S33 and S34) of the first embodiment shown in FIG. 8 and thus will not be described in detail.

Laser Welding of Negative Fixing Member 16 and Connection Member 34

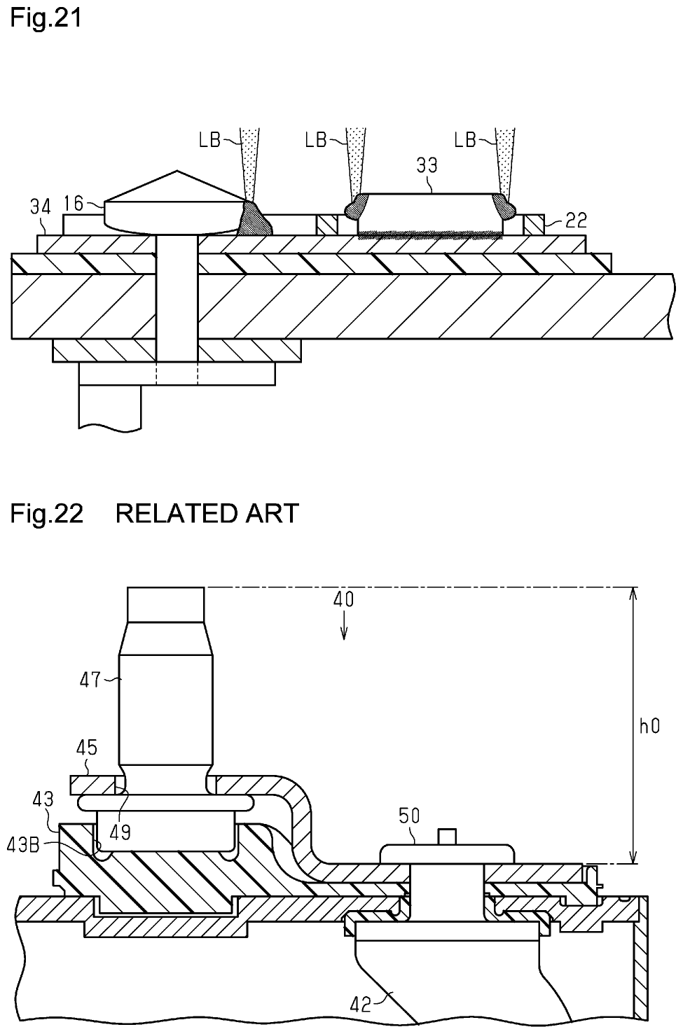

As shown in FIG. 21, when welding the external terminal 33 to the busbar 22, the negative fixing member 16 may be welded to the connection member 34. Such collective welding simplifies the process.

### Modified Examples

In the same manner as the first embodiment, the light receiving port 23 shown in FIG. 15 may be provided and irradiated with the laser beam LB to diffusion bond the bonded surface 30.

In addition, to diffusion bond the bonded surface 30, the laser beam LB may be emitted from the side of the connection member 34 to heat the bonded surface 30.

The connection member 34 may be ultrasonic-bonded to the external terminal 33 by the ultrasonic bonding machine 32 from the side of the connection member 34 before the connection member 34 is fixed.

### Effects of Second Embodiment

(11) The flat connection member 34 extends along the lid 11b of the battery case 11, and the external terminal 33 is solid-phase-bonded to the connection member 34. Thus, the maximum height h2 from the connection member 34 to the negative terminal unit 15 shown in FIG. 20B is less than the height h0 of the second embodiment shown in FIG. 22 and the height h1 shown in FIG. 11B. This allows for a compact configuration of a battery pack.

(12) The step of ultrasonically bonding the connection member 34 to the external terminal 33 (S32) may be executed as a separate step from the step of assembling the cell battery 10. In addition, the subsequent diffusion bonding in the present embodiment may be executed as a separate step from the step of welding the busbar 22 and the step of assembling the cell battery 10.

(13) In this case, the application of heat for ultrasonic bonding and diffusion bonding of the present embodiment is not limited to from the side of the external terminal 33 and may be performed from the side of the connection member 34.

(14) Ultrasonic bonding is performed between a flat surface of the connection member 34 and a flat surface of the external terminal 33. This facilitates mutual oscillation of the connection member 34 and the external terminal 33 and efficiently ultrasonic bonds the connection member 34 to the external terminal 33 without losing energy.

(15) After the connection member 34 is swaged and fixed by the negative fixing member 16, when thermal energy for welding the busbar 22 to the external terminal 33 is used to perform the diffusion bonding of the present embodiment, the same effect as the first embodiment is obtained. In addition, as shown in FIG. 21, the connection member 34 is swaged to the negative fixing member 16 at the same time as the connection member 34 is welded to the negative fixing member 16. Thus, the process is efficiently executed.

### Modified Examples

The shape of the busbar 22 is not limited to those illustrated and may be any shape and, for example, oval-coin-shaped or L-shaped. The connector 22e shown in FIG. 16 may include a curved portion. The curved portion 22c shown in FIG. 4 may be curved downward.

The busbar 22 shown in FIG. 11 includes the cutaway portions 22d. However, the cutaway portions 22d are not necessary components. In addition, the shape of the cutaway portions 22d may be designed in any manner.

The busbar 22 does not necessarily have to be fitted to the external terminals 17 and 33 and may be welded to the upper surfaces of the external terminals 17 and 33.

The fixing of the negative fixing member 16 is not limited to swaging and may be screw-fastening or welding.

The assembled battery 1 is not limited to the configuration in which the cell batteries 10 are stacked in the thickness-wise direction as shown in FIGS. 1 and 2. The cell batteries 10 may be combined in series in the longitudinal direction so as to be located under the floor of a vehicle. Further, it is also preferred that the assembled battery 1 includes a plurality of such series arrangements that are laid out in a plane.

The shape of the light receiving port 23 provided for the diffusion bonding of the bonded surface 30 is not limited to that shown in FIG. 15. The number of openings and the area of each opening and the position may be designed in any manner taking into consideration thermal conductivity.

The procedure of a flowchart is an example. One skilled in the art may add, remove, and modify steps of the flowchart or may change the order of the steps.

The embodiments are examples of the present disclosure. One skilled in the art may add, remove, and modify the configuration of the embodiments within the scope of the claims.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for manufacturing a lithium-ion rechargeable battery, the lithium-ion rechargeable battery including
a power generating element,
a battery case accommodating the power generating element,
a current collector terminal electrically connected to a negative electrode body of the power generating element, and
a negative terminal unit connected to the current collector terminal and configured to conduct electricity from an inside to an outside of the battery case, the negative terminal unit being formed of copper (Cu) or a Cu alloy and including a fixing member fixing the battery case to the current collector terminal, the method comprising:
ultrasonically bonding an external terminal formed of aluminum (Al) or an Al alloy to the fixing member of the negative terminal unit; and
heating the external terminal that has undergone the ultrasonic bonding to form a diffusion-bonded portion and an intermolecular-bonded portion in a bonded surface of the external terminal and the fixing member of the negative terminal unit.

2. The method according to claim 1, wherein the heating the external terminal that has undergone the ultrasonic bonding facilitates diffusion bonding of the bonded surface using thermal energy for welding the external terminal.

3. The method according to claim 2, wherein the heating the external terminal that has undergone the ultrasonic bonding uses heat of laser welding that welds the external terminal to a busbar as thermal energy.

4. A method for manufacturing a lithium-ion rechargeable battery, the lithium-ion rechargeable battery including a power generating element, a battery case accommodating the power generating element, a current collector terminal electrically connected to a negative electrode body of the power generating element, and a negative terminal unit connected to the current collector terminal and configured to conduct electricity from an inside to an outside of the battery case, and the negative terminal unit being formed of copper (Cu) or a Cu alloy and including a fixing member fixing the battery case to the current collector terminal, the method comprising:
connecting a connection member formed of Cu or a Cu alloy to the fixing member of the negative terminal unit;
ultrasonically bonding an external terminal formed of aluminum (Al) or an Al alloy to the connection member; and
heating a bonded surface of the external terminal and the connection member, which is obtained by the ultrasonic bonding, to form a diffusion-bonded portion and an intermolecular-bonded portion.

5. The method according to claim 4, wherein the heating a bonded surface of the external terminal and the connection member, which is obtained by the ultrasonic bonding, facilitates diffusion bonding of the bonded surface using thermal energy for welding the external terminal.

6. The method according to claim 5, wherein the heating a bonded surface of the external terminal and the connection member, which is obtained by the ultrasonic bonding, uses heat for laser welding the external terminal to a busbar as thermal energy.

7. The method according to claim 4, further comprising:
welding the fixing member to the connection member that is fixed to the fixing member, wherein the welding is performed continuously with laser welding that welds the external terminal to a busbar in the heating of the bonded surface of the external terminal and the connection member, which is obtained by the ultrasonic bonding.

8. A lithium-ion rechargeable battery, comprising:
a power generating element;
a battery case accommodating the power generating element;
a current collector terminal electrically connected to a negative electrode body of the power generating element;
a negative terminal unit connected to the current collector terminal and configured to conduct electricity from an inside to an outside of the battery case, the negative terminal unit being formed of copper (Cu) or a Cu alloy and including a fixing member fixing the battery case to the current collector terminal; and
an external terminal formed of aluminum (Al) or an Al alloy bonded to the fixing member, wherein the fixing member of the negative electrode unit and the external terminal include a bonded surface including a diffusion-bonded portion and an intermolecular-bonded portion.

9. An assembled battery comprising:
the lithium-ion rechargeable battery according to claim 8, wherein the assembled battery further comprises a busbar formed of Al or an Al alloy that is laser-welded to the external terminal.

10. The assembled battery according to claim 9, wherein the external terminal includes an upper surface and a light receiving port formed in the upper surface and configured to be irradiated with a laser beam.

11. A lithium-ion rechargeable battery, comprising:
a power generating element;
a battery case accommodating the power generating element;
a current collector terminal electrically connected to a negative electrode body of the power generating element;
a negative terminal unit connected to the current collector terminal and configured to conduct electricity from an inside to an outside of the battery case, the negative terminal unit being formed of copper (Cu) or a Cu alloy and including a fixing member fixing the battery case to the current collector terminal;
a connection member connected to the fixing member and formed of Cu or a Cu alloy; and
an external terminal bonded to the connection member and formed of aluminum (Al) or an Al alloy, wherein the connection member and the external terminal include a bonded surface including a diffusion-bonded portion and an intermolecular-bonded portion.

12. An assembled battery, comprising:
the lithium-ion rechargeable battery according to claim 11, wherein the lithium-ion rechargeable battery further includes Al or an Al alloy that is laser-welded to the external terminal.

13. The assembled battery according to claim 12, wherein the external terminal includes an upper surface and a light receiving port formed in the upper surface and configured to be irradiated with a laser beam.
